(19) United States
(12) Patent Application Publication
(10) Pub. No.: US 2016/0055585 A1
(43) Pub. Date: Feb. 25, 2016

(54) SMART BETA FACTOR DEPOSITION SYSTEM

(71) Applicant: BANK OF AMERICA CORPORATION, Charlotte, NC (US)

(72) Inventor: Steven K. Stearns, Fairfield, CT (US)

(21) Appl. No.: 14/463,343

(22) Filed: Aug. 19, 2014

(51) Int. Cl. G06Q 40/06

(52) U.S. Cl. CPC G06Q 40/06

(57) ABSTRACT

Disclosed is a smart beta factor deposition system for constructing an investment portfolio. The smart beta factor deposition system typically includes a processor, a memory, and a deposition module stored in the memory. The deposition module is typically configured for: defining a plurality of factor sleeves, each factor sleeve defining (i) a beta factor model, (ii) one or more asset classes and/or asset class categories, (iii) a size, and (iv) one or more position sizes; for each sleeve's beta factor model, determining a score of each of a plurality of securities; for each factor sleeve, selecting one or more securities based on the score of each security according to the sleeve's beta factor model to form positions until the sleeve's size has been reached; and combining the positions of each factor sleeve to create the investment portfolio.

### FIELD OF THE INVENTION

The present invention embraces a smart beta factor deposition system for constructing an investment portfolio. The smart beta factor deposition system typically includes a processor, a memory, and a deposition module stored in the memory. The deposition module is typically configured for: defining a plurality of factor sleeves, each factor sleeve defining a beta factor model and a size; for each sleeve's beta factor model, determining a score of each of a plurality of securities; for each factor sleeve, selecting one or more securities based on the score of each security according to the sleeve's beta factor model to form positions until the sleeve's size has been reached; and combining the positions of each factor sleeve to create the investment portfolio.

### BACKGROUND

Traditionally, an investor in securities has had to choose between an actively managed portfolio in which investments are actively selected to seek a return that outperforms of the market and a passively-managed portfolio in which investments mirror one or more standard market indexes based on market capitalization. Recently, a third investment style, smart beta investing has become more popular. Smart beta investing combines aspects of active and passive portfolio management. Instead of seeking to mirror a standard market index, smart beta investing employs a strategy based on one or more factors in an effort to seek a return and/or reduce volatility in comparison with standard market indexes. For example, a smart beta strategy might weight or screen a standard market index based on one or more factors, such as cash flow, dividends, or volatility. Once the rules for the strategy have been defined, these rules are passively followed.

Mean variance optimization is a theory used for constructing investment portfolios. Under mean variance optimization, rather than individually selecting assets for inclusion in a portfolio, a set of portfolios is determined, in which each portfolio in the set includes a collection of assets with (i) collective expected returns greater than any other portfolio with the same or lesser risk and (ii) lesser risk than any other portfolio with the same or greater return. Determining this set of portfolios relies on the expected return and standard deviation of return for each asset as well as the relative correlations between the expected returns of the assets (e.g., the extent to which the deviation of one asset from its expected return correlates with the deviation of another asset from its expected return). Under mean variance optimization, the expected return, standard deviation of return, and correlations of the assets is based on historical data. Mean variance optimization returns a set of portfolios of varying levels of risk and expected return from which an investor can choose the portfolio best suited for the investor's risk tolerance.

That said, a need exists for an improved way of constructing an investment portfolio.

### SUMMARY

In one aspect, the present invention embraces a smart beta factor deposition system and an associated method and computer program product. The smart beta factor deposition system typically includes a non-transitory computer-readable storage medium and at least one computer processor. The smart beta factor deposition system also typically includes a deposition module stored in the memory and executable by the computer processor.

In one embodiment, the deposition module includes computer-executable instructions for causing the computer processor to be configured for: defining a plurality of factor sleeves, each factor sleeve defining (i) a beta factor model, (ii) one or more asset classes and/or asset class categories, (iii) a size, and (iv) one or more position sizes; for each factor sleeve's beta factor model, determining a score of each of a plurality of securities; for each factor sleeve, selecting one or more securities based on the score of each security according to the factor sleeve's beta factor model until the factor sleeve's size has been reached, each selected security being associated with the factor sleeve's one or more asset classes and/or asset class categories, each selected security forming a position having a size equal to one of the factor sleeve's position sizes; and combining the positions of each factor sleeve to create the investment portfolio.

In a particular embodiment, the deposition module comprises computer-executable instructions for causing the computer processor to be configured for, in one or more customer accounts, conducting one or more securities transactions based on the positions in the investment portfolio.

In another particular embodiment, each factor sleeve defines a rebalancing schedule; and the deposition module comprises computer-executable instructions for causing the computer processor to be configured for: regularly updating the score of each of the plurality of securities for each factor sleeve's beta factor model; updating the positions of each factor sleeve based on each factor sleeve's rebalancing schedule; and based on updating the positions of at least one factor sleeve, conducting one or more securities transactions in one or more customer accounts.

In another particular embodiment, the deposition module comprises computer-executable instructions for causing the computer processor to be configured for: defining one or more asset class limits and/or asset class category limits; determining that one of the asset class limits and/or asset class category limits has been reached; and based on determining that one of the asset class limits and/or asset class category limits has been reached, not selecting any additional securities that would cause the asset class limits and/or asset class category limits to be exceeded.

In another particular embodiment, the deposition module comprises computer-executable instructions for causing the computer processor to be configured for determining the liquidity of each security; wherein each position's size is based on the liquidity of the selected security forming the position.

In another particular embodiment, each factor sleeve defines a rebalancing schedule; and the deposition module comprises computer-executable instructions for causing the computer processor to be configured for: regularly updating the score of each of the plurality of securities for each factor sleeve's beta factor model; and updating the positions of each factor sleeve based on each factor sleeve's rebalancing schedule.

In another particular embodiment, for each factor sleeve's beta factor model, determining the score of each of the plurality of securities comprises determining the score of one or more exchange traded funds; and for each factor sleeve's beta factor model, determining the score of one or more exchange traded funds comprises: determining the asset allocation of each exchange traded fund, each exchange traded fund holding one or more constituent holdings; retrieving factor data regarding each constituent holding; and based on the retrieved factor data and the asset allocation for each exchange traded fund, determining a score of each exchange traded fund according to the factor sleeve's beta factor model.

In another particular embodiment, for each factor sleeve's beta factor model, determining the score of each of the plurality of securities comprises determining the score of one or more (i) mutual funds, (ii) insurance separate accounts, and/or (iii) securities having alternative investments; and for each factor sleeve's beta factor model, determining the score of one or more mutual funds, insurance separate accounts, and/or securities having alternative investments comprises: determining that the asset allocation of one or more of the mutual funds, insurance separate accounts, and/or securities having alternative investments is unavailable; for each mutual fund, insurance separate account, and/or security having alternative investments with an unavailable asset allocation, identifying a substitute asset allocation having one or more constituent holdings; retrieving factor data regarding each constituent holding; and based on the retrieved factor data and the substitute asset allocation for each mutual fund, insurance separate account, and/or security having alternative investments with an unavailable asset allocation, determining a score of each mutual fund, insurance separate account, and/or security having alternative investments with an unavailable asset allocation according to the factor sleeve's beta factor model.

In a second embodiment, the deposition module includes computer-executable instructions for causing the computer processor to be configured for: determining transaction costs associated with a plurality of customer accounts; determining an investment opportunity set associated with each of the plurality of customer accounts, each investment opportunity set comprising a plurality of securities; defining a plurality of factor sleeves, each factor sleeve defining (i) a beta factor model, (ii) one or more asset classes and/or asset class categories, (iii) a size, (iv) one or more position sizes, (v) a rebalancing schedule, and (vi) an assigned customer account, wherein the assigned customer account for each factor sleeve is selected from the plurality of customer accounts and defined based on the transaction costs associated with the plurality of customer accounts and each factor sleeve's rebalancing schedule; for each factor sleeve's beta factor model, determining a score of each security in the investment opportunity set of the factor sleeve's assigned customer account; for each factor sleeve, selecting one or more securities from the investment opportunity set of the factor sleeve's assigned customer account based on the score of each security according to the factor sleeve's beta factor model until the factor sleeve's size has been reached, each selected security being associated with the factor sleeve's one or more asset classes and/or asset class categories, each selected security forming a position having a size equal to one of the factor sleeve's position sizes; combining the positions of each factor sleeve to create the investment portfolio; and, based on the positions in the investment portfolio and based on each factor sleeve's assigned customer account, conducting one or more securities transactions.

In a particular embodiment, the deposition module comprises computer-executable instructions for causing the computer processor to be configured for: determining the transaction frequency limits associated with the plurality of customer accounts; wherein the assigned customer account for each factor sleeve is defined further based on the transaction frequency limits associated with the plurality of customer accounts.

In another particular embodiment, the deposition module comprises computer-executable instructions for causing the computer processor to be configured for: regularly updating the score of each of the plurality of securities for each factor sleeve's beta factor model; updating the positions of each factor sleeve based on each factor sleeve's rebalancing schedule; and based on updating the positions of at least one factor sleeve, conducting one or more securities transactions in one or more customer accounts.

In another particular embodiment, the deposition module comprises computer-executable instructions for causing the computer processor to be configured for: defining one or more asset class limits and/or asset class category limits; determining that one of the asset class limits and/or asset class category limits has been reached; and based on determining that one of the asset class limits and/or asset class category limits has been reached, not selecting any additional securities that would cause the asset class limits and/or asset class category limits to be exceeded.

In another particular embodiment, the deposition module comprises computer-executable instructions for causing the computer processor to be configured for: determining the liquidity of each security; wherein each position's size is based on the liquidity of the selected security forming the position.

In another particular embodiment, for each factor sleeve's beta factor model, determining the score of each security in the investment opportunity set of the factor sleeve's assigned customer account comprises determining the score of one or more exchange traded funds; and for each factor sleeve's beta factor model, determining the score of one or more exchange traded funds comprises: determining the asset allocation of each exchange traded fund, each exchange traded fund holding one or more constituent holdings; retrieving factor data regarding each constituent holding; and based on the retrieved factor data and the asset allocation for each exchange traded fund, determining a score of each exchange traded fund according to the factor sleeve's beta factor model.

In another particular embodiment, for each factor sleeve's beta factor model, determining the score of each security in the investment opportunity set of the factor sleeve's assigned customer account comprises determining the score of one or more (i) mutual funds, (ii) insurance separate accounts, and/or (iii) securities having alternative investments; and for each factor sleeve's beta factor model, determining the score of one or more mutual funds, insurance separate accounts, and/or securities having alternative investments comprises: determining that the asset allocation of one or more of the mutual funds, insurance separate accounts, and/or securities having alternative investments is unavailable; for each mutual fund, insurance separate account, and/or security having alternative investments with an unavailable asset allocation, identifying a substitute asset allocation having one or more constituent holdings; retrieving factor data regarding each constituent holding; and based on the retrieved factor data and the substitute asset allocation for each mutual fund, insurance separate account, and/or security having alternative investments with an unavailable asset allocation, determining a score of each mutual fund, insurance separate account, and/or security having alternative investments with an unavailable asset allocation according to the factor sleeve's beta factor model.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 depicts a method of constructing an investment portfolio for a customer in accordance with an aspect of the present invention;

FIG. 2 depicts a graphical representation of the construction of an investment portfolio in accordance with an embodiment of the present invention;

FIG. 3 depicts a method of constructing an investment portfolio for a customer in accordance with another aspect of the present invention;

FIG. 4 depicts a deposition system and operating environment in accordance with an aspect of the present invention; and

FIG. 5 schematically depicts a deposition system in accordance with an aspect of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, an insurance account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution.

In some embodiments, the “user” may be a customer (e.g., an account holder or a person who has an account (e.g., banking account, credit account, brokerage account or the like) at the entity) or potential customer (e.g., a person who has submitted an application for an account, a person who is the target of marketing materials that are distributed by the entity, a person who applies for a loan that not yet been funded). In other embodiments, the “user” may refer to an employee of the entity.

In one aspect, the present invention generally relates to a smart beta factor deposition system for creating an investment portfolio by selecting securities (e.g., stocks, bonds, mutual funds, exchange traded funds, real estate investment trusts, and the like) having the highest scores according to different beta factor models. As used herein, securities include insurance separate accounts, which are accounts maintained by insurance companies in which a customer having certain insurance products (e.g., variable annuity or variable universal life) can invest, and which are synonymous to mutual funds in which a customer can invest in a retirement account. After the highest scoring securities have been selected, an investor can then purchase securities that correspond to the selection of securities that make up the created investment portfolio. By selecting securities based on different beta factor models an investment portfolio can be efficiently created without the need to employ the complex correlation models required by mean variance optimization. Although such complex correlation models generally are not employed by the present system, the present system is able to construct diversified portfolios with desirable risk and return. In addition, because many of the beta factor models employed by the present system do not rely on historical data to the same extent that such data is used in mean variance optimization, the present system is more able to adapt to changing market conditions.

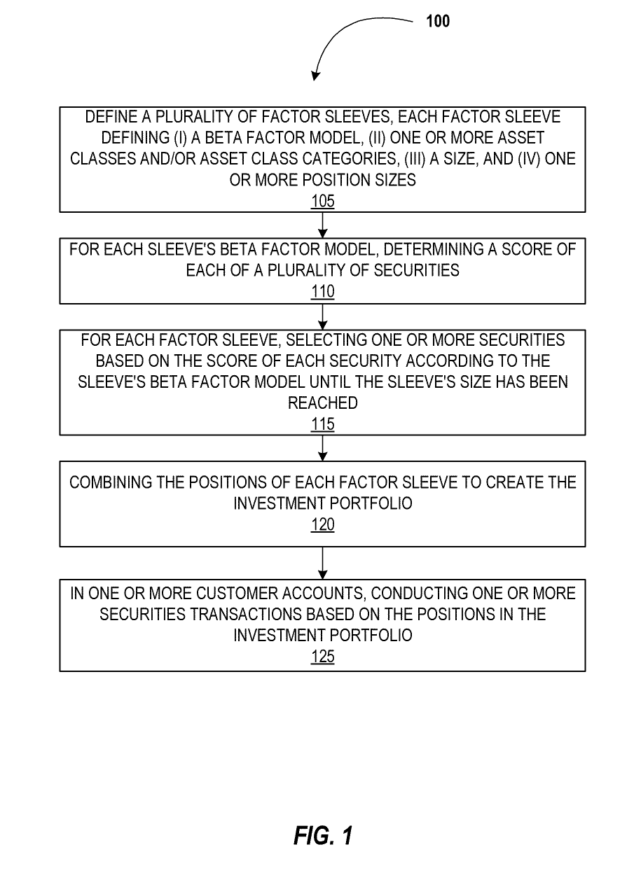

Accordingly, FIG. 1 depicts a method 100 of creating an investment portfolio (e.g., by employing a smart beta factor deposition system provided by a financial institution) for a customer in accordance with an aspect of the present invention. The investment portfolio may then be used to build an actual portfolio that corresponds to the created investment portfolio. In this regard, the customer typically has one or more accounts, such as investment, retirement, or brokerage accounts, through which securities may be purchased. The customer's accounts may be maintained by the financial institution that provides the deposition system and/or by other financial institutions.

First, at block 105, a plurality of factor sleeves are defined, typically within the smart beta factor deposition system. Each factor sleeve includes a plurality of parameters that are employed to build a subset of the customer's investment portfolio. In this regard, each factor sleeve typically defines (i) a beta factor model that is used to score a plurality of securities, (ii) one or more asset classes and/or asset class categories from which top scoring securities are selected, (iii) a size, and (iv) one or more position sizes.

Each beta factor model typically incorporates one or more beta factors to evaluate the efficacy of investing in a particular security, typically over a defined time horizon. For example, a beta factor model may be (i) a short term (e.g., 0-6 month investment time horizon) dynamic model that heavily weights the momentum beta factor, (ii) an intermediate term (e.g., 6-24 month investment time horizon) tactical model that utilizes value and momentum beta factors, (iii) a long term (e.g., 1-5 year investment time horizon) strategic model that heavily weights the value beta factor, (iv) a long term (e.g., 3-5 year investment time horizon) income model that heavily weights the income beta factor, and (v) a long term (e.g., 3-5 year investment time horizon) core model that utilizes quality and value beta factors. Such models may also incorporate any fees or transaction costs (e.g., to take into the account the bid-offer spread for a security) associated with the securities. Based on the scores of securities according to a factor sleeve's beta factor model, the top scoring securities (e.g., the ten securities with the highest scores) are selected for the customer's investment portfolio. In some embodiments, the models are static (i.e., do not change). That said, in other embodiments, one or more models might be dynamically altered based on changing conditions or user preferences. For example, weighting assigned to different factors employed in a particular model may change depending on changing market conditions.

The top scoring securities are selected from the asset classes and/or asset class categories defined for each factor sleeve. Securities may be broadly grouped into different asset classes, such as equities (e.g., stocks), fixed income (e.g., bonds), real and alternative assets (e.g., real estate and commodities), and cash, in which securities in the same asset class typically have similar characteristics. Securities within the same asset class may be more narrowly grouped into different asset class categories, such as securities that relate to the same country, region, size (e.g., small, medium, or large), style (e.g., value or growth), or sector (e.g., staples, healthcare, telecomm, utilities, financials, technology, industrial, materials, and the like). Real and alternative assets may be divided between growth-oriented (higher volatility) real and alternative assets (e.g., real estate, infrastructure, natural resources, energy, commodities, higher volatility alternative investments, and precious metals) and income-oriented (low volatility) real and alternative assets (e.g., treasury inflation-protected securities, floating rate bonds, non-traditional bonds, lower volatility alternative investments, and currency). Alternative securities may be ETFs, mutual funds, or insurance separate accounts that seek to replicate alternative strategies often employed by hedge funds. Some factor sleeves may be applicable to multiple asset classes or asset class categories. That said, other factor sleeve may be applicable to a single asset class or asset class category. Indeed, in some instances a particular beta factor model may only be applicable to a particular asset class. By way of example, top scoring equities and fixed income investments (e.g., bonds) may be selected under a first factor sleeve, top scoring fixed income investments may be selected under a second factor sleeve, and top scoring US equities may be selected under a third factor sleeve.

The size of each sleeve relates to the sleeve's size in comparison to the size of the investment portfolio. Accordingly, the size of each sleeve may be expressed as a dollar value and/or as a percent of the investment portfolio. For example, an investment portfolio with a total size of $100,000 may be built using five different equally weighted factor sleeves, whereby each factor sleeve has a size of 20% and/or $20,000.

Each factor sleeve typically defines one or more position sizes. Each position size relates the size of each position (i.e., security selected for inclusion in the investment portfolio) selected under each factor sleeve. For example, if the portfolio has a total size of $100,000 and each factor sleeve has a size of $20,000, each position size may be 4% of the total portfolio or $4,000. Thus, in this example, each selected security would have a size of $4,000. In some embodiments, each factor sleeve may define multiple position sizes, where the size of each position is based on the liquidity of the underlying security. In this regard, some securities may have lower levels of trading activity that may make it more difficult to liquidate (e.g., sell) such securities quickly. Accordingly, smaller position sizes may be employed for securities with lower liquidity. For example, each factor sleeve may define a position size of 4% for highly liquid securities, 2% for securities with medium liquidity, and 1% for securities with low liquidity.

Each factor sleeve may also define a rebalancing schedule. The rebalancing schedule for each factor sleeve is based on the factor sleeve's beta factor model and specifies the frequency at which the positioned selected under a factor sleeve should be updated. For example, shorter term beta factor models may require weekly or monthly rebalancing, intermediate term beta factor models may require monthly or quarterly rebalancing, and longer term beta factor models may require quarterly or annual rebalancing.

Because the customer may have multiple accounts for investing, each factor sleeve may also define a particular account of the customer. In other words, each factor sleeve may be assigned to a particular customer account. In some instances, similar factor sleeves (e.g., factor sleeves having the same beta factor model and asset classes and/or asset class categories) may be assigned to different customer accounts. Where each sleeve is assigned to a particular customer account, the size of each sleeve may reflect a dollar value and/or a percent of the assigned customer account.

In combination, the factor sleeves are used to build the investment portfolio. Various factor sleeves may be selected based on the customer's desired risk and return. In particular, the asset classes/asset class categories and sizes of the factor sleeves may be selected or adjusted based on the customer's desired risk and return. For example, a customer seeking higher risks and returns may employ more or larger sleeves specific to equities and fewer or smaller sleeves specific to fixed income investments, and a customer seeking lower risks and returns may employ fewer or smaller sleeves specific to equities and more or larger sleeves specific to fixed income investments. In some embodiments, at least a portion of the investment portfolio may be built from a sleeve that does not employ a beta factor model. For example, a portion (e.g., 10%) of the investment portfolio may be built from mutual funds or exchange traded funds that reflect a market-capitalization-weighted standard index (e.g., a market-capitalization-weighted standard stock market index).

An exemplary set of factor sleeves used to build an investment portfolio is depicted in Table 1 (below). The primary beta factors for each sleeve are the beta factor(s) that primarily make up each sleeve's beta factor model. Those sleeves listed without beta factors are used to select securities that reflect standard market indexes. These sleeves may be assigned to different customer accounts with some sleeves being duplicated across multiple accounts.

TABLE 1

| | | Asset Classes/Asset | | | Rebalancing |
|---|---|---|---|---|---|
| Sleeve Name | Primary Beta Factors | Class Categories | Size | Position Sizes | Schedule |
| Dynamic1 | Momentum | Equities | 4% | 4% (high liquidity) | Monthly |
| | | | | 2% (medium liquidity) | |
| | | | | 1% (low liquidity) | |
| Dynamic2 | Momentum | Fixed Income | 4% | 4% (high liquidity) | Monthly |
| | | | | 2% (medium liquidity) | |
| | | | | 1% (low liquidity) | |
| Dynamic3 | Momentum | All | 8% | 4% (high liquidity) | Monthly |
| | | | | 2% (medium liquidity) | |
| | | | | 1% (low liquidity) | |
| Tactical1 | Value | Equities | 4% | 4% (high liquidity) | Quarterly |
| | Momentum | | | 2% (medium liquidity) | |
| | | | | 1% (low liquidity) | |
| Tactical2 | Value | Fixed Income | 4% | 4% (high liquidity) | Quarterly |
| | Momentum | | | 2% (medium liquidity) | |
| | | | | 1% (low liquidity) | |
| Tactical3 | Value | Growth Real Assets | 8% | 4% (high liquidity) | Quarterly |
| | Momentum | | | 2% (medium liquidity) | |
| | | | | 1% (low liquidity) | |
| Tactical4 | Value | Income Real Assets | 4% | 4% (high liquidity) | Quarterly |
| | Momentum | | | 2% (medium liquidity) | |
| | | | | 1% (low liquidity) | |
| Tactical5 | Value | All | 8% | 4% (high liquidity) | Quarterly |
| | Momentum | | | 2% (medium liquidity) | |
| | | | | 1% (low liquidity) | |
| Strategic1 | Value | Equities | 8% | 4% (high liquidity) | Annually |
| | | | | 2% (medium liquidity) | |
| | | | | 1% (low liquidity) | |
| Strategic2 | Value | Fixed Income | 4% | 4% (high liquidity) | Annually |
| | | | | 2% (medium liquidity) | |
| | | | | 1% (low liquidity) | |
| Income | Shareholder Yield | Equities | 8% | 4% (high liquidity) | Annually |
| | | | | 2% (medium liquidity) | |
| | | | | 1% (low liquidity) | |
| Core | Quality | Equities | 8% | 4% (high liquidity) | Annually |
| | Value | | | 2% (medium liquidity) | |
| | | | | 1% (low liquidity) | |
| Base1 | N.A. | US Equities | 4% | 4% (high liquidity) | Annually |
| | | | | 2% (medium liquidity) | |
| | | | | 1% (low liquidity) | |
| Base2 | N.A. | Int'l Equities | 4% | 4% (high liquidity) | Annually |
| | | | | 2% (medium liquidity) | |
| | | | | 1% (low liquidity) | |
| Base3 | N.A. | US Fixed Income | 4% | 4% (high liquidity) | Annually |
| | | | | 2% (medium liquidity) | |
| | | | | 1% (low liquidity) | |
| Base4 | N.A. | Int'l Fixed Income | 4% | 4% (high liquidity) | Annually |
| | | | | 2% (medium liquidity) | |
| | | | | 1% (low liquidity) | |
| Base5 | N.A. | Growth Real Assets | 4% | 4% (high liquidity) | Annually |
| | | | | 2% (medium liquidity) | |
| | | | | 1% (low liquidity) | |
| Base6 | N.A. | Income Real Assets | 4% | 4% (high liquidity) | Annually |
| | | | | 2% (medium liquidity) | |
| | | | | 1% (low liquidity) | |
| Base7 | N.A. | Cash | 4% | N.A. | Annually |

In some embodiments, one or more asset class and/or asset class category limits may be defined. Such asset class and/or asset class category limits define the maximum amount of the investment portfolio that may be made up of securities that fall within such asset class and/or asset class category. For example, an asset class limit may define that the investment portfolio shall include no more than 20% fixed income investments. Typically, once such a limit has been reached, no additional securities will be selected if such securities fall within the limited asset class and/or asset class category. In other words, once such a limit has been reached, any additional securities that would cause the limit to be exceeded should not be selected.

At block 110, a score for each of a plurality of securities is determined based on each factor sleeve's beta factor model. In particular, for each factor sleeve, securities that fall within the factor sleeve's asset classes/asset class categories are scored in accordance with the factor sleeve's beta factor model. In this regard, factor data regarding the securities is retrieved. This factor data typically includes financial data, financial ratios, and/or other metrics regarding each security. By way of example, such factor data may include various metrics such as price, earnings, cash flow, market capitalization, volatility, price to earnings, price to book value, dividend yield, and the like. In some instances, such factor data may include rankings, projections, and/or recommendations from analysts. Typically, the factor data for each security includes a score or data related to one or more smart beta factors. Such beta factors may include value, momentum, quality, capital stewardship (e.g., yield or growth), and/or trend strength. Factor data related to the value beta factor may include: intrinsic value, relative value, price to book, price to earnings, price to cash flow, price to sales, and projected total return. Factor data related to the momentum beta factor may include: trailing total return, composite price momentum, and analyst revision momentum. Factor data related to the quality beta factor may include: return on capital, return on equity, earnings quality, and beta. Factor data related to the capital stewardship beta factor may include: shareholder yield, dividend year, buyback yield, dividend growth, historical dividend growth, projected dividend growth, dividend quality, and projected earnings growth. Factor data related to the trend strength beta factor may include various technical indicators. In some embodiments, the factor data may be retrieved from one or more factor databases, which may be maintained by the financial institution or by a third party data provider. Because some of the metrics (e.g., the market price of assets) may be constantly changing, such factor databases may be constantly updated (e.g., in real time), and, accordingly, updated factor data may be continuously retrieved from such factor databases. In other embodiments, the deposition system for creating the investment portfolio may be in communication with one or more factor data feeds, which may be provided by the financial institution or by a third party data provider. Such factor feeds may provide live (e.g., real time) factor data.

In typical embodiments, the securities may be exchange traded funds. Accordingly, to determine the score of each exchange traded (ETF) according to each factor sleeve's beta factor model, the asset allocation of each exchange traded fund typically must first be determined. In some embodiments, some of the ETFs may include the same asset class. In some embodiments, some of the ETFs may include the assets of the same asset class category. In other embodiment, the ETFs may relate to differing asset classes and/or asset class categories. The assets held by the ETF (i.e., the ETF's constituent holdings) may be held in equal or unequal proportions. For example, one ETF may hold 20 stocks with the stocks being held in equal proportions. By way of further example, another ETF may hold numerous stocks in varying proportions that reflect a market-capitalization-weighted standard stock market index. Accordingly, the asset allocation for each ETF includes the proportion of each constituent holding held by each ETF. Information necessary to determine the asset allocation of each ETF is typically retrieved from one or more ETF databases, which may be maintained by the financial institution or by a third party data provider. Because the holdings of ETFs often change over time (e.g., due to decisions by active managers or due to a change in the makeup of an underlying market index), such ETF databases may be regularly updated to ensure that up to date information regarding each ETF can be retrieved. Next, factor data regarding each constituent holding must be retrieved. Thereafter, in order to determine the score of each ETF in accordance with each beta factor model, factor data for each constituent holding held by the ETF is aggregated and weighted in accordance with the ETF's asset allocation.

In some instances, the asset allocation of a security may be unavailable. Accordingly, if the actual asset allocation of a security is unavailable, a substitute asset allocation may be identified and used instead. In this regard, at least some of the securities may be mutual funds or insurance separate accounts. One of the problems associated with scoring mutual funds and insurance separate accounts in accordance with each beta factor model is that asset allocations of mutual funds and insurance separate accounts are generally not publically available. Accordingly, although some factor data regarding each mutual fund and insurance separate accounts can be retrieved, other factor data (e.g., projected returns) cannot be readily retrieved or calculated. Therefore, if certain factor data is unavailable, such unavailable factor data may be replaced with factor data from the constituents of the closest corresponding market index, which have publically available asset allocations. In other words, the asset allocation of the market index may function as a substitute asset allocation if the actual asset allocation of a security is unavailable. For example, the projected total return of a U.S. large cap equities mutual fund may be determined by identifying the closest corresponding U.S. large cap equities index and using data regarding the index's constituents, as well as any fees associated with the mutual fund, to determine the projected total return.

In some embodiments, at least some of the securities may relate to alternative investments. One of the problems associated with scoring funds and other securities having alternative investments in accordance with each beta factor model is that asset allocations of securities having alternative investments are generally not publically available. Accordingly, although some factor data regarding each security having alternative investments can be retrieved, other factor data (e.g., projected returns) cannot be readily retrieved or calculated. Therefore, if certain factor data is unavailable, such unavailable factor data may be replaced with factor data derived from the projected constituent makeup of securities employing the same or similar type of alternative strategy. In other words, the projected constituent makeup of a type of alternative strategy may function as a substitute asset allocation if the actual asset allocation of a security employing a similar alternative strategy. For example, certain third party data providers may project the constituent makeup of securities that employ certain alternative strategies. The projected constituent makeup of the closest alternative strategy may then be retrieved and used as a substitute for unavailable factor data for a particular security having alternative investments.

Next, at block 115, securities (e.g., the top scoring securities) are selected for each factor sleeve based on the score of each security according to the sleeve's beta factor model until the sleeve's size has been reached. In this regard, each selected security forms a position having a size equal to one of the factor sleeve's position sizes. Each security is typically selected from the asset classes and/or asset class categories associated with the applicable factor sleeve. For example, if a particular factor sleeve has a size of 20% and defines a position size of 4%, then the five securities with the highest scores according to the factor sleeve's beta factor model may be selected to form positions.

In some embodiments, one of more accounts of the customer may have a limited number of securities in which the customer can invest using such accounts. For example, a particular retirement account may only have thirty different securities in which the customer can invest. Accordingly, before selecting the top scoring securities, the securities available for investment (i.e., the investment opportunity set) in the customer's account may be determined. Thereafter, the top scoring securities are selected from the securities available for investing. If different customer accounts have differing investment opportunity sets, top scoring securities may be separately selected for each account. To facilitate separate selection of securities for each account, each factor sleeve may be assigned to a particular customer account.

As noted, in some embodiments, a factor sleeve may define multiple position sizes, where the size of each position is based on the liquidity of the underlying security. Accordingly, the liquidity of each selected security may be determined (e.g., based on received liquidity data). Based on this liquidity, the position size of each selected security may be determined. By way of example, a factor sleeve may define a position size of 4% for highly liquid securities, 2% for securities with medium liquidity, and 1% for securities with low liquidity. Accordingly, the number of securities selected for this factor sleeve may vary depending on the liquidity of the highest scoring securities. For example, the five securities with the highest scores according to the factor sleeve's beta factor model may be selected to form positions if each of the five securities has high liquidity. That said, the six highest scoring securities may be selected if four of the six securities have high liquidity, and the remaining two securities have medium liquidity. In addition, the seven highest scoring securities may be selected if four of the seven securities have high liquidity, one of the securities has medium liquidity, and the remaining two securities have low liquidity.

In some embodiments, once a security has been selected under one factor sleeve, that same security will not be selected under any other factor sleeve. For example, if a particular factor sleeve has a size of 20% and defines a position size of 4%, then the five securities with the highest scores according to the factor sleeve's beta factor model would ordinarily be selected to form positions. That said, if the fifth highest scoring security has already been selected under another factor sleeve, then the fifth highest security would not be selected, but would be replaced with the sixth highest scoring security, assuming the sixth highest scoring security has not been selected under another factor sleeve. If the sixth highest scoring security has been selected under another factor sleeve, then the security with the highest score and not already selected under another factor sleeve would be selected. That said, in other embodiments, the same security may be selected under multiple factor sleeves.

If one or more asset class and/or asset class category limits have been defined, once such a limit has been reached, no additional securities will be selected if such securities fall within the limited asset class and/or asset class category. For example, if a particular factor sleeve has a size of 20% and defines a position size of 4%, then the five securities with the highest scores according to the factor sleeve's beta factor model would ordinarily be selected to form positions. That said, if selecting the fifth highest scoring security would result in an asset class or asset class category limit being exceed, then the fifth highest security would not be selected, but would be replaced with the sixth highest scoring security, assuming the sixth highest scoring security does not fall within the limited asset class or asset class category.

At block 120, the positions selected for each factor sleeve are combined to create the investment portfolio. Information regarding the investment profile may then be presented to the customer and/or to an employee (e.g., an investment advisor) of the financial institution who is assisting the customer.

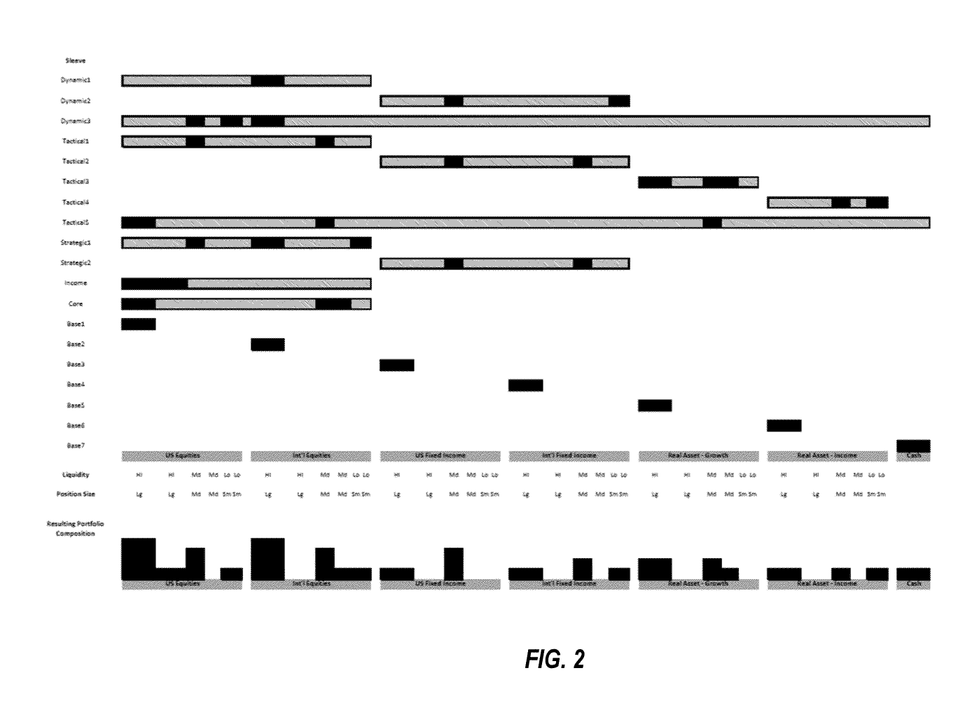

FIG. 2 depicts a graphical representations of the construction of an investment portfolio based on the factor sleeves included in Table 1. In this regard, FIG. 2 depicts each factor sleeve included in Table 1. Each factor sleeve in FIG. 2 is positioned over its associated asset class(es) and/or asset class category(ies). Each position selected for each factor sleeve is also depicted, along with the size each position. Finally, FIG. 2 includes the resulting investment portfolio that combines each selected position.

Based on the positions in the created investment portfolio, at block 125, securities transactions are conducted (e.g., securities are purchased) in one of more accounts of the customer to build an actual portfolio that corresponds to the created investment portfolio. If sleeves are assigned to particular customer accounts, such transactions are performed based on such assignment. For example, for a first position selected under a first sleeve assigned to a first customer account, a corresponding transaction is performed in the first customer account, and, for a second position selected under a second sleeve assigned to a second customer account, a corresponding transaction is performed in the second customer account.

Subsequently, the positions selected under each factor sleeve typically are updated based on the each sleeve's defined rebalancing schedule. As noted, different factor sleeves may have different rebalancing schedules. In this regard, similar to the process described with respect to blocks 110 and 115, the scores of the securities are updated based on each factor sleeve's beta factor model and the top scoring securities are selected. If there are any changes to the top scoring securities, the positions in the investment portfolio are updated and, if necessary, securities transactions are conducting (e.g., securities may be bought and sold) to insure that the securities held in the customer's account(s) reflect the updated positions.

In some instances, the positions selected under different factor sleeves may change without requiring securities transactions to be conducted. For example, a particular security may initially be selected under a first factor sleeve. Subsequently, during a rebalancing the security is found to no longer be a top scoring security under the first factor sleeve, but is a top scoring security under the second factor sleeve. Accordingly, it may not be necessary to buy or sell any positions with respect to this security.

As noted, in some instances the customer may have multiple accounts into which securities may be purchased. For example, the customer may have one or more retirement accounts, which may have limitations on the customer's ability to deposit, withdrawn, or transfer funds, and one or more brokerage accounts. The costs associated with these accounts may vary. For example, some accounts may charge annual fees (e.g., annual fees of either a flat amount or a percentage of the value of the account), but might not charge transaction-based fees. That said, other accounts might charge transaction-based fees and/or have other transaction-based costs. Such transaction-based costs may result in undesirably high costs when the customer engages in a higher volume of transactions. However, certain factor sleeves may define a rebalancing schedule that requires frequent (e.g., weekly or monthly) rebalancing, thereby resulting in higher transaction volumes associated with such factor sleeves. Accordingly, in another aspect, the present invention embraces a deposition system for creating an investment portfolio that attempts to reduce the effects of the transaction costs associated with the customer's accounts.

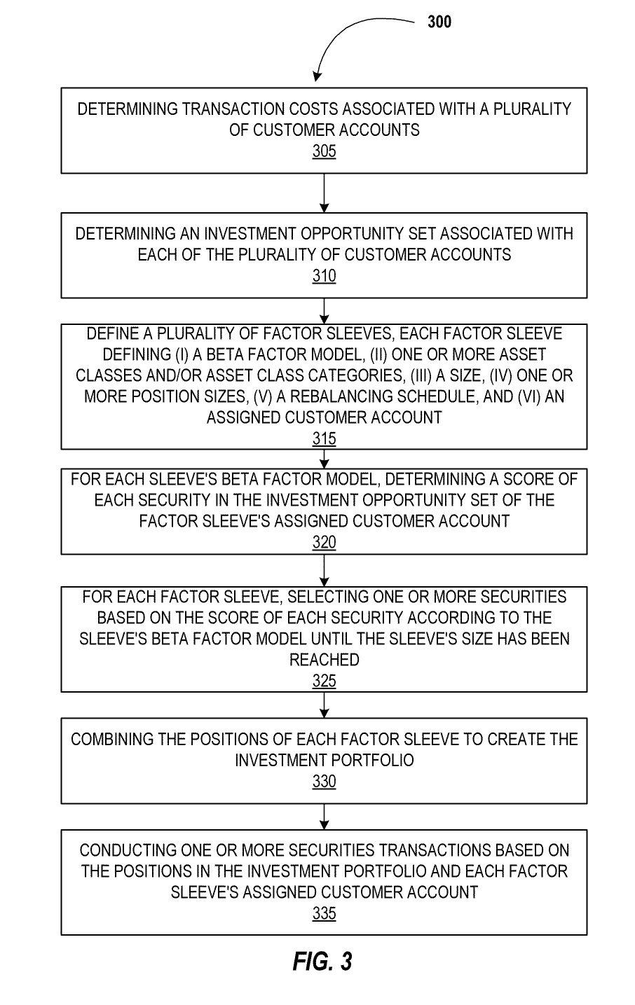

In this regard, FIG. 3 depicts a method 300 of creating an investment portfolio in accordance with this aspect of the present invention.

First at block 305, the transaction costs associated with a plurality of customer accounts are determined. These customer accounts are accounts of the customer in which securities may be purchased to build an actual portfolio that corresponds to the created investment portfolio. These transaction costs may include fees or any other costs incurred by the customer due to buying or selling a security in a particular account. Other costs (e.g., annual fees) associated with the customers' accounts are also typically determined. In some instances, an account may impose a limit on the frequency in which securities may be traded. Accordingly, in some embodiments, any transaction frequency limits for the customer's accounts may be determined.

At block 310, an investment opportunity set is determined for each customer account. The opportunity set for each customer account includes all securities that can be invested in using such customer account. In this regard, some customer accounts may be used to invest in almost any security; however, other customer accounts may have a limited number of securities in which the customer can invest. For example, a particular retirement account may only have thirty different securities in which the customer can invest.

Next, at block 315, a plurality of factor sleeves are defined, typically within a deposition system for creating an investment portfolio provided by a financial institution. Each factor sleeve includes a plurality of parameters that are employed to build a subset of a customer's investment portfolio. In this regard, each factor sleeve typically defines (i) a beta factor model that is used to score a plurality of securities, (ii) one or more asset classes and/or asset class categories from which top scoring securities are selected, (iii) a size, (iv) one or more position sizes, and (v) a rebalancing schedule.

Each factor sleeve is typically assigned to a customer account. The assigned customer account for each factor sleeve is selected from the plurality of customer accounts and is defined based on the transaction costs associated with the plurality of customer accounts and each factor sleeve's rebalancing schedule. In this regard, a factor sleeve requiring more frequent rebalancing is typically assigned to a customer account that has low transaction costs. A factor sleeve requiring less frequent rebalancing (e.g., annual rebalancing) may be assigned to a customer account that has low transaction costs or to a customer account that has higher transaction costs. Indeed, it may be beneficial to assign factor sleeves requiring less frequent rebalancing to an account having high transaction costs and a low annual fee as opposed to an account having low transaction costs and a higher annual fee. In some instances, similar factor sleeves (e.g., factor sleeves having the same beta factor model and asset classes and/or asset class categories) may be assigned to different customer accounts.

As noted, in some embodiments, any transaction frequency limits for the customer's accounts may be determined. If any accounts have a transaction frequency limit that conflicts with a factors sleeve's rebalancing schedule, then such transaction frequency limit are also taken into consideration when assigning factor sleeves to customer accounts. In particular, a factor sleeve will typically not be assigned to a customer account with a transaction frequency limit that conflicts with the factor sleeve's rebalancing schedule. For example, if a particular customer account requires purchased securities to be held for thirty days before they can be sold, then a factor sleeve requiring weekly rebalancing would not be assigned to such customer account.

At block 320, a score for each of a plurality of securities is determined based on each factor sleeve's beta factor model. In particular, for each factor sleeve, securities that fall within the factor sleeve's asset classes/asset class categories are scored in accordance with the factor sleeve's beta factor model.

Next, at block 325, securities (e.g., the top scoring securities) are selected for each factor sleeve based on the score of each security according to the sleeve's beta factor model until the sleeve's size has been reached. In this regard, each selected security forms a position having a size equal to one of the factor sleeve's position sizes. Each security is typically selected from the asset classes and/or asset class categories associated with the applicable factor sleeve. In addition, each security is typically selected from the opportunity set of the applicable factor sleeve's assigned customer account. In this regard, if a particular account has an opportunity set that includes 30 different securities, then for each factor sleeve assigned to that particular account the top scoring securities will be selected from that opportunity set of 30 different securities.

At block 330, the positions selected for each factor sleeve are combined to create the investment portfolio. Information regarding the investment profile may then be presented to the customer and/or to an employee (e.g., an investment advisor) of the financial institution who is assisting the customer.

At block 335, based on the positions selected for inclusions in each customer account and based on each factor sleeve's assigned customer account, securities transactions are conducted (e.g., securities are purchased) in each customer account to build an actual portfolio that corresponds to the created investment portfolio. Subsequently, the positions selected under each factor sleeve typically are updated based on the each sleeve's defined rebalancing schedule.

As an alternative to assigning factor sleeves requiring more frequent rebalancing to customer accounts with low transaction costs, high scoring securities that strongly correlate to a factor sleeve's beta factor model may be identified and placed in customer accounts that have high transaction costs. For example, if an exchange traded fund is based on a particular beta factor, this exchange traded fund may strongly correlate to a factor sleeve's beta factor model in which the same beta factor is a primary component. Such exchange traded fund might not be one of the highest scoring securities, but still might have a desirably high score (e.g., in the top 10 percent or top 20 percent of scored securities). After identifying high scoring and strongly correlating securities, such securities may be selected for inclusions in one or more customer accounts, including customer accounts with higher transaction costs, and corresponding securities transactions are conducted. In addition, frequency of the factor sleeve's rebalancing schedule may be reduced (e.g., from monthly rebalancing to yearly rebalancing).

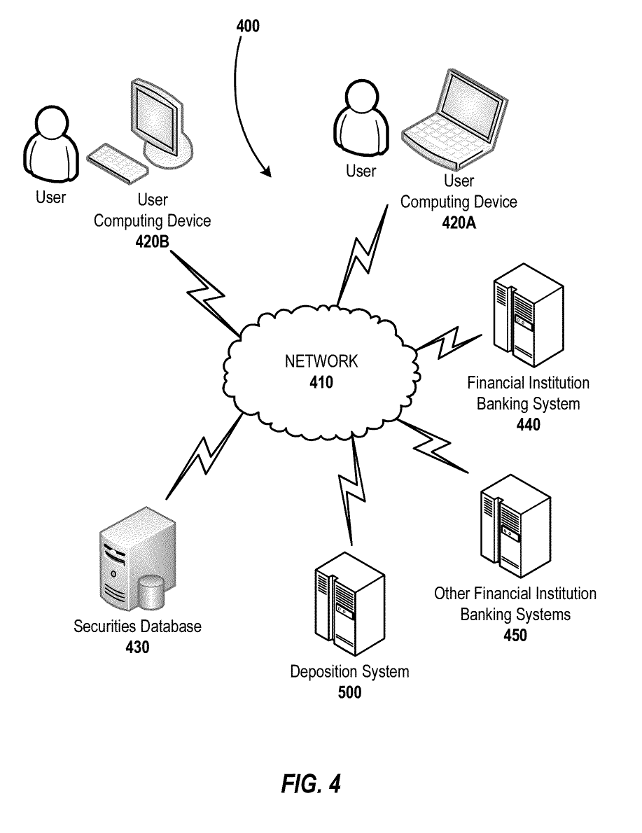

FIG. 4 depicts an operating environment 400 according to one embodiment of the present invention. The operating environment 400 includes a deposition system 500 for creating an investment portfolio that selects securities having the highest scores according to different beta factor models. In addition, one or more users, each having a user computing device 420, such as a PC, laptop, mobile phone, tablet, television, mobile device, or the like, may be in communication with the deposition system 500 via a network 410, such as the Internet, wide area network, local area network, Bluetooth network, near field network, or any other form of contact or contactless network. Typically, each user is an employee of the financial institution. That said, the user may be a customer. The deposition system 400 is typically in communication with one or more securities databases 430 via the network 410. The deposition system 500 may regularly (e.g., daily, weekly, monthly, or quarterly) retrieve information regarding securities from the securities database 430 in order to score the securities based on different beta factor models. For example, the deposition system 500 may continuously (e.g., every few seconds or minutes) retrieve factor data from the securities database 430 (e.g., receive data from the securities database 430 via a data stream), thereby allowing the deposition system 500 to continuously update the scores of securities (e.g., in real time). Other information regarding securities (e.g., the asset allocation of one or more ETFs) may also be retrieved from the securities database 430. In order for the deposition system 500 to facilitate securities transactions in customer accounts, the deposition system 500 is typically in communication (e.g., via the network 410) with the banking system 440 of the financial institution. In addition, the deposition system 500 is typically in communication with the banking systems 450 of other financial institutions, thereby allowing the deposition system 500 to direct securities transactions in accounts maintained by such other financial institutions.

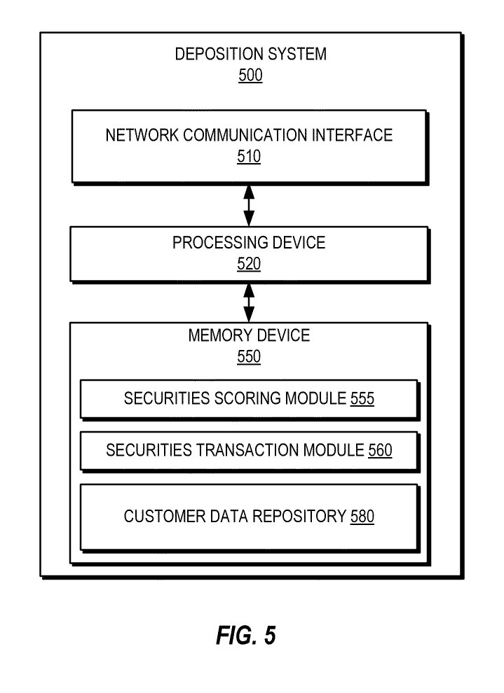

FIG. 5 depicts the deposition system 500 in more detail. As depicted in FIG. 5 the deposition system 500 typically includes various features such as a network communication interface 510, a processing device 520, and a memory device 550. The network communication interface 510 includes a device that allows the deposition system 500 to communicate over the network 410 (shown in FIG. 4) with the user computing devices 520. In this regard, the deposition system may graphically present (e.g., communicate over the network 410) an interface (e.g., a graphical user interface) to each computing device, which can then be displayed on each user computing device to allow each user to interact with the deposition system 500. For example, the user may interact with the deposition system 500 to select (e.g., select from predefined factor sleeves) or define factor sleeves for a particular customer based on the customer's desired rate of return and risk tolerance. The user may also define asset class and/or asset class category limits.

As used herein, a “processing device,” such as the processing device 520, generally refers to a device or combination of devices having circuitry used for implementing the communication and/or logic functions of a particular system. For example, a processing device 520 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 520 may further include functionality to operate one or more software programs based on computer-executable program code thereof, which may be stored in a memory. As the phrase is used herein, a processing device 520 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device,” such as the memory device 550, generally refers to a device or combination of devices that store one or more forms of computer-readable media for storing data and/or computer-executable program code/instructions. Computer-readable media is defined in greater detail below. For example, in one embodiment, the memory device 550 includes any computer memory that provides an actual or virtual space to temporarily or permanently store data and/or commands provided to the processing device 520 when it carries out its functions described herein.

As noted, the deposition system 500 is configured to score securities according to one or more smart beta factor models and use these scores to select the highest scoring securities for inclusion in a customer's investment portfolio. Accordingly, the deposition system 500 typically includes a securities scoring module 555 stored in the memory device 550, which scores securities and selects the highest scoring securities to create investment portfolios. A securities transaction module 560 may communicate with the banking system 440 of the financial institution and the banking systems 450 of other financial institutions to direct securities transactions in customer accounts (e.g., by transmitting buying and selling instructions). The deposition system 500 also typically includes a customer data repository 580. The customer data repository 580 includes data regarding each customer, such as: information regarding each customer's accounts, including any associated costs (e.g., transaction costs); the factor sleeves applicable to each customer; and any defined asset class and/or asset class category limits.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A smart beta factor deposition system for constructing an investment portfolio for a customer, the smart beta factor deposition system comprising:
a non-transitory computer-readable storage medium;
at least one computer processor; and
a deposition module stored in the memory and executable by the computer processor, the deposition module comprising computer-executable instructions for causing the computer processor to be configured for:
defining a plurality of factor sleeves, each factor sleeve defining (i) a beta factor model, (ii) one or more asset classes and/or asset class categories, (iii) a size, and (iv) one or more position sizes;
for each factor sleeve's beta factor model, determining a score of each of a plurality of securities;
for each factor sleeve, selecting one or more securities based on the score of each security according to the factor sleeve's beta factor model until the factor sleeve's size has been reached, each selected security being associated with the factor sleeve's one or more asset classes and/or asset class categories, each selected security forming a position having a size equal to one of the factor sleeve's position sizes; and
combining the positions of each factor sleeve to create the investment portfolio.

2. The smart beta factor deposition system according to claim 1, wherein the deposition module comprises computer-executable instructions for causing the computer processor to be configured for:
in one or more customer accounts, conducting one or more securities transactions based on the positions in the investment portfolio.

3. The smart beta factor deposition system according to claim 2, wherein:
each factor sleeve defines a rebalancing schedule; and
the deposition module comprises computer-executable instructions for causing the computer processor to be configured for:
regularly updating the score of each of the plurality of securities for each factor sleeve's beta factor model;
updating the positions of each factor sleeve based on each factor sleeve's rebalancing schedule; and
based on updating the positions of at least one factor sleeve, conducting one or more securities transactions in one or more customer accounts.

4. The smart beta factor deposition system according to claim 1, wherein the deposition module comprises computer-executable instructions for causing the computer processor to be configured for:
defining one or more asset class limits and/or asset class category limits;
determining that one of the asset class limits and/or asset class category limits has been reached; and
based on determining that one of the asset class limits and/or asset class category limits has been reached, not selecting any additional securities that would cause the asset class limits and/or asset class category limits to be exceeded.

5. The smart beta factor deposition system according to claim 1, wherein the deposition module comprises computer-executable instructions for causing the computer processor to be configured for:
determining the liquidity of each security;
wherein each position's size is based on the liquidity of the selected security forming the position.

6. The smart beta factor deposition system according to claim 1, wherein:
each factor sleeve defines a rebalancing schedule; and
the deposition module comprises computer-executable instructions for causing the computer processor to be configured for:
regularly updating the score of each of the plurality of securities for each factor sleeve's beta factor model; and
updating the positions of each factor sleeve based on each factor sleeve's rebalancing schedule.

7. The smart beta factor deposition system according to claim 1, wherein:
for each factor sleeve's beta factor model, determining the score of each of the plurality of securities comprises determining the score of one or more exchange traded funds; and
for each factor sleeve's beta factor model, determining the score of one or more exchange traded funds comprises:
determining the asset allocation of each exchange traded fund, each exchange traded fund holding one or more constituent holdings;
retrieving factor data regarding each constituent holding; and
based on the retrieved factor data and the asset allocation for each exchange traded fund, determining a score of each exchange traded fund according to the factor sleeve's beta factor model.

8. The smart beta factor deposition system according to claim 1, wherein:
for each factor sleeve's beta factor model, determining the score of each of the plurality of securities comprises determining the score of one or more (i) mutual funds, (ii) insurance separate accounts, and/or (iii) securities having alternative investments; and
for each factor sleeve's beta factor model, determining the score of one or more mutual funds, insurance separate accounts, and/or securities having alternative investments comprises:
determining that the asset allocation of one or more of the mutual funds, insurance separate accounts, and/or securities having alternative investments is unavailable;
for each mutual fund, insurance separate account, and/or security having alternative investments with an unavailable asset allocation, identifying a substitute asset allocation having one or more constituent holdings;
retrieving factor data regarding each constituent holding; and
based on the retrieved factor data and the substitute asset allocation for each mutual fund, insurance separate account, and/or security having alternative investments with an unavailable asset allocation, determining a score of each mutual fund, insurance separate account, and/or security having alternative investments with an unavailable asset allocation according to the factor sleeve's beta factor model.

9. A computer program product for constructing an investment portfolio for a customer, the computer program product comprising a non-transitory computer-readable storage medium having computer-executable instructions for causing a computer processor to be configured for:
defining a plurality of factor sleeves, each factor sleeve defining (i) a beta factor model, (ii) one or more asset classes and/or asset class categories, (iii) a size, and (iv) one or more position sizes;
for each factor sleeve's beta factor model, determining a score of each of a plurality of securities;
for each factor sleeve, selecting one or more securities based on the score of each security according to the factor sleeve's beta factor model until the factor sleeve's size has been reached, each selected security being associated with the factor sleeve's one or more asset classes and/or asset class categories, each selected security forming a position having a size equal to one of the factor sleeve's position sizes; and
combining the positions of each factor sleeve to create the investment portfolio.

10. The computer program product according to claim 9, wherein the non-transitory computer-readable storage medium has computer-executable instructions for causing the computer processor to be configured for:
in one or more customer accounts, conducting one or more securities transactions based on the positions in the investment portfolio.

11. The computer program product according to claim 10, wherein:
each factor sleeve defines a rebalancing schedule; and
the non-transitory computer-readable storage medium has computer-executable instructions for causing the computer processor to be configured for:
regularly updating the score of each of the plurality of securities for each factor sleeve's beta factor model;
updating the positions of each factor sleeve based on each factor sleeve's rebalancing schedule; and
based on updating the positions of at least one factor sleeve, conducting one or more securities transactions in one or more customer accounts.

12. The computer program product according to claim 9, wherein the non-transitory computer-readable storage medium has computer-executable instructions for causing the computer processor to be configured for:
defining one or more asset class limits and/or asset class category limits;
determining that one of the asset class limits and/or asset class category limits has been reached; and
based on determining that one of the asset class limits and/or asset class category limits has been reached, not selecting any additional securities that would cause the asset class limits and/or asset class category limits to be exceeded.

13. The computer program product according to claim 9, wherein the non-transitory computer-readable storage medium has computer-executable instructions for causing the computer processor to be configured for:
determining the liquidity of each security;
wherein each position's size is based on the liquidity of the selected security forming the position.

14. The computer program product according to claim 9, wherein:
each factor sleeve defines a rebalancing schedule; and
the non-transitory computer-readable storage medium has computer-executable instructions for causing the computer processor to be configured for:
regularly updating the score of each of the plurality of securities for each factor sleeve's beta factor model; and
updating the positions of each factor sleeve based on each factor sleeve's rebalancing schedule.

15. The computer program product according to claim 9, wherein:
for each factor sleeve's beta factor model, determining the score of each of the plurality of securities comprises determining the score of one or more exchange traded funds; and
for each factor sleeve's beta factor model, determining the score of one or more exchange traded funds comprises:
determining the asset allocation of each exchange traded fund, each exchange traded fund holding one or more constituent holdings;
retrieving factor data regarding each constituent holding; and
based on the retrieved factor data and the asset allocation for each exchange traded fund, determining a score of each exchange traded fund according to the factor sleeve's beta factor model.

16. The computer program product according to claim 9, wherein:
for each factor sleeve's beta factor model, determining the score of each of the plurality of securities comprises determining the score of one or more (i) mutual funds, (ii) insurance separate accounts, and/or (iii) securities having alternative investments; and
for each factor sleeve's beta factor model, determining the score of one or more mutual funds, insurance separate accounts, and/or securities having alternative investments comprises:
determining that the asset allocation of one or more of the mutual funds, insurance separate accounts, and/or securities having alternative investments is unavailable;
for each mutual fund, insurance separate account, and/or security having alternative investments with an unavailable asset allocation, identifying a substitute asset allocation having one or more constituent holdings;
retrieving factor data regarding each constituent holding; and
based on the retrieved factor data and the substitute asset allocation for each mutual fund, insurance separate account, and/or security having alternative investments with an unavailable asset allocation, determining a score of each mutual fund, insurance separate account, and/or security having alternative investments with an unavailable asset allocation according to the factor sleeve's beta factor model.

17. A computerized method for constructing an investment portfolio for a customer, comprising:
defining, via a computer processor, a plurality of factor sleeves, each factor sleeve defining (i) a beta factor model, (ii) one or more asset classes and/or asset class categories, (iii) a size, and (iv) one or more position sizes;
for each factor sleeve's beta factor model, determining, via a computer processor, a score of each of a plurality of securities;
for each factor sleeve, selecting, via a computer processor, one or more securities based on the score of each security according to the factor sleeve's beta factor model until the factor sleeve's size has been reached, each selected security being associated with the factor sleeve's one or more asset classes and/or asset class categories, each selected security forming a position having a size equal to one of the factor sleeve's position sizes; and
combining, via a computer processor, the positions of each factor sleeve to create the investment portfolio.

18. The method according to claim 17, comprising:
in one or more customer accounts, conducting one or more securities transactions based on the positions in the investment portfolio.

19. The method according to claim 18, wherein:
each factor sleeve defines a rebalancing schedule; and
the method comprises:
regularly updating the score of each of the plurality of securities for each factor sleeve's beta factor model;
updating the positions of each factor sleeve based on each factor sleeve's rebalancing schedule; and
based on updating the positions of at least one factor sleeve, conducting one or more securities transactions in one or more customer accounts.

20. The method according to claim 17, comprising:
defining one or more asset class limits and/or asset class category limits;
determining that one of the asset class limits and/or asset class category limits has been reached; and
based on determining that one of the asset class limits and/or asset class category limits has been reached, not selecting any additional securities that would cause the asset class limits and/or asset class category limits to be exceeded.

21. The method according to claim 17, comprising:
determining the liquidity of each security;
wherein each position's size is based on the liquidity of the selected security forming the position.

22. The method according to claim 17, wherein:
each factor sleeve defines a rebalancing schedule; and
the method comprises:
regularly updating the score of each of the plurality of securities for each factor sleeve's beta factor model; and
updating the positions of each factor sleeve based on each factor sleeve's rebalancing schedule.

23. The method according to claim 17, wherein:
for each factor sleeve's beta factor model, determining the score of each of the plurality of securities comprises determining the score of one or more exchange traded funds; and
for each factor sleeve's beta factor model, determining the score of one or more exchange traded funds comprises:
determining the asset allocation of each exchange traded fund, each exchange traded fund holding one or more constituent holdings;
retrieving factor data regarding each constituent holding; and
based on the retrieved factor data and the asset allocation for each exchange traded fund, determining a score of each exchange traded fund according to the factor sleeve's beta factor model.

24. The method according to claim 17, wherein:
for each factor sleeve's beta factor model, determining the score of each of the plurality of securities comprises determining the score of one or more (i) mutual funds, (ii) insurance separate accounts, and/or (iii) securities having alternative investments; and
for each factor sleeve's beta factor model, determining the score of one or more mutual funds, insurance separate accounts, and/or securities having alternative investments comprises:
determining that the asset allocation of one or more of the mutual funds, insurance separate accounts, and/or securities having alternative investments is unavailable;
for each mutual fund, insurance separate account, and/or security having alternative investments with an unavailable asset allocation, identifying a substitute asset allocation having one or more constituent holdings;
retrieving factor data regarding each constituent holding; and
based on the retrieved factor data and the substitute asset allocation for each mutual fund, insurance separate account, and/or security having alternative investments with an unavailable asset allocation, determining a score of each mutual fund, insurance separate account, and/or security having alternative investments with an unavailable asset allocation according to the factor sleeve's beta factor model.
